(19) United States
(12) Patent Application Publication
(10) Pub. No.: US 2002/0188830 A1
(43) Pub. Date: Dec. 12, 2002

(54) Bit replacement and extraction instructions

(76) Inventors: Brian Boles, Mesa, AZ (US); Michael Catherwood, Pepperell, MA (US)

Correspondence Address: SWIDLER BERLIN SHEREFF FRIEDMAN, LLP, 3000 K STREET, NW, BOX IP, WASHINGTON, DC, 20007, US

(21) Appl. No.: 09/870,637

(22) Filed: Jun. 1, 2001

(51) Int. Cl. G06F 9/00

(52) U.S. Cl. 712/224

(57) ABSTRACT

Bit value transfer operation instructions are provided. The bit value transfer operation instructions themselves include four instructions, each for selecting a bit value contained in a source bit position of a data memory location and writes the bit value to a destination bit position of another data memory location. Moreover, the instructions specify a source bit position of a data memory location containing a bit value to select, a destination bit position of another data memory location to write the bit value, and the data memory location of an operand from which to read or write the bit value. Processing a bit value transfer operation instruction includes fetching and decoding a bit value transfer instruction. The method further includes executing the bit value transfer instruction on a source bit position of a first data memory location to select a bit value in the source bit position of the first data memory location. The bit position of the first data memory location is specified in the bit value transfer instruction. The method further includes writing the value to a destination bit position of a second data memory location. The destination bit position specified in the bit value transfer instruction.

### BACKGROUND OF THE INVENTION

1. Field of the Invention

The present invention relates to systems and methods for instruction processing and, more particularly, to systems and methods for providing bit value transfer operation instruction processing, pursuant to which a bit value in a source bit position of a register is retrieved and set as the bit value of a destination bit position.

2. Description of Prior Art:

Processors, including microprocessors, digital signal processors and microcontrollers, operate by running software programs that are embodied in one or more series of instructions stored in a memory. The processors run the software by fetching the instructions from the series of instructions, decoding the instructions and executing them. Processors, including digital signal processors, are conventionally adept at processing instructions that operate on a data word or data byte. For example, a processor is adept at performing operations using all bits of a register containing data. Likewise, a processor is conventionally adept at performing operations on single bits when provided in a fixed limited portion of the overall data space. In general, bit value transfer operations are performed by reading bit values from data space and writing them to a register specific for the operation. These types of bit value transfer operations make inefficient use of processor resources and tend to reduce the performance of the processor due to the large number of operands read and the overall number of bits values transferred between the data spaces. For example, encryption algorithms employ bit-wise transfer operations on a processor implementing a number of operands and a number of bits. Accordingly, there will be an impact on the performance of the encryption algorithm that may cause impractical delays depending on the application.

There is a need for a new method of implementing bit transfer operations within a processor that makes efficient use of processor cycles and instructions efficiently. There is a further need for a new method of implementing bit transfer operation for bit intensive applications such as encryption applications and other mathematically intensive applications.

### SUMMARY OF THE INVENTION

According to embodiments of the present invention, a method and a processor for processing bit value transfer operation instructions are provided. The bit transfer operation instructions themselves include four instructions, each for selecting a bit value contained in a source bit position of a data memory location and writes the bit value to a destination bit position of another data memory location. Moreover, the instructions specify a source bit position of a data memory location containing a bit value to select, a destination bit position of another data memory location to write the bit value, and the data memory location of an operand from which to read or write the bit value.

These instructions may be executed in one processor cycle and with one program instruction utilizing bit value transfer operation logic within the processor. For encryption and other applications which continuously implement bit manipulation techniques, these instructions may improve performance over conventional techniques by several times.

A method of processing a bit value transfer operation instruction according to an embodiment of the present invention includes fetching and decoding a bit value transfer instruction. The method further includes executing the bit value transfer instruction on a source bit position of a first data memory location to select a bit value in the source bit position of the first data memory location. The bit position of the first data memory location is specified in the bit value transfer instruction. The method further includes writing the value to a destination bit position of a second data memory location. The destination bit position specified in the bit value transfer instruction.

In an embodiment of the present invention, the method includes reading an operand at the first memory location and copying the bit value at the source bit position of the operand during the execution of the bit value transfer instruction. The method further includes writing the operand to the first memory location. The bit value transfer instruction may be a first test bit value transfer instruction. The first test bit value transfer instruction specifies a carry status bit position as the destination bit position of the second memory location. The first test bit value transfer instruction specifies a register as the first data memory location or an address in data memory as the first data memory location.

Alternatively, the bit value transfer instruction may be a second test bit value transfer instruction. The second test bit value transfer instruction specifies a zero status bit position as the destination bit position of the second memory location. The second test bit value transfer instruction specifies a register as the first data memory location or an address in data memory as the first data memory location.

In an embodiment of the present invention, the method includes reading an operand at the first memory location and copying the bit value at the source bit position of the operand during the execution of the bit value transfer instruction. The method further includes writing the operand to the first memory location. The bit value transfer instruction may be a first write bit value transfer instruction. The first write bit value transfer instruction specifies a zero status bit position as the source bit position of the first memory location. The first write bit value transfer instruction specifies a register as the second data memory location or an address in data memory as the second data memory location. Alternatively, the bit value transfer instruction may be a second write bit value transfer instruction. The second write bit value transfer instruction specifies a carry status bit position as the source bit position of the first memory location. The second write bit value transfer instruction specifies a register as the second data memory location or an address in data memory as the second data memory location.

A processor for processing a bit value transfer operation instruction according to an embodiment of the present invention includes a program memory for storing instructions including a bit value transfer operation instruction, a program counter for identifying current instructions for processing, and an arithmetic logic unit (ALU) for executing instructions within the program memory. The ALU includes bit value transfer operation logic for executing the bit value transfer operation instruction on a source bit position of a first data memory location to select a bit value in the source bit position of the first data memory location and writing the value to a destination bit position of a second data memory location. The bit position of the first data memory location and the destination bit position are specified in the bit value transfer instruction.

### BRIEF DESCRIPTION OF THE DRAWINGS

The above described features and advantages of the present invention will be more fully appreciated with reference to the detailed description and appended figures in which:

FIG. 1 depicts a functional block diagram of an embodiment of a processor chip within which embodiments of the present invention may find application;

FIG. 2 depicts a functional block diagram of a data busing scheme for use in a processor, which has a microcontroller and a digital signal processing engine, within which embodiments of the present invention may find application;

FIG. 3 depicts a functional block diagram of a processor configuration for processing bit transfer operation instructions according to embodiments of the present invention;

FIG. 4 depicts a method of processing bit value transfer operation instructions according to embodiments of the present invention; and

FIG. 5 depicts a table of bit value transfer operation instructions according to embodiments of the present invention.

### DETAILED DESCRIPTION OF THE INVENTION

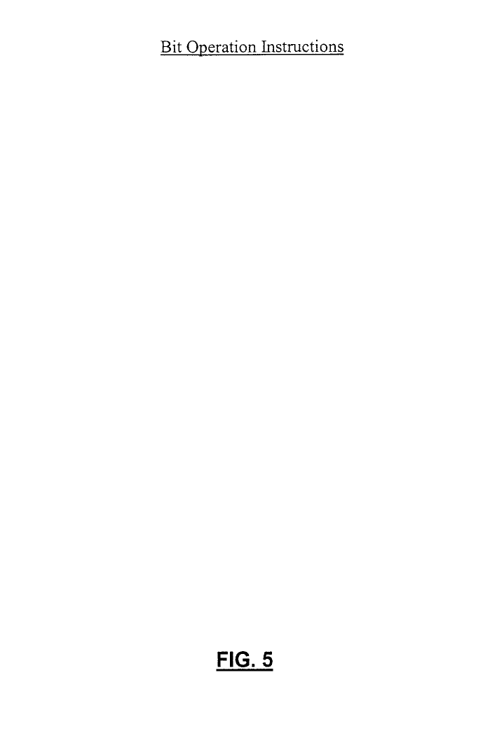

According to embodiments of the present invention, a method and a processor for processing bit value transfer operation instructions are provided. The bit transfer operation instructions themselves include four instructions, each for selecting a bit value contained in a source bit position of a data memory location and writing the bit value to a destination bit position of another data memory location. Moreover, the instructions specify a source bit position of a data memory location containing a bit value to select, a destination bit position of another data memory location to write the bit value, and the data memory location of an operand from which to read or write the bit value. The instructions are shown in FIG. 5.

These instructions may be executed in one processor cycle and with one program instruction utilizing bit operation logic within the processor. This represents a significant performance advantage over traditional bit operation implemented techniques. For encryption and other applications, which implement frequent bit manipulation operations, these instructions may improve performance over conventional techniques by several times.

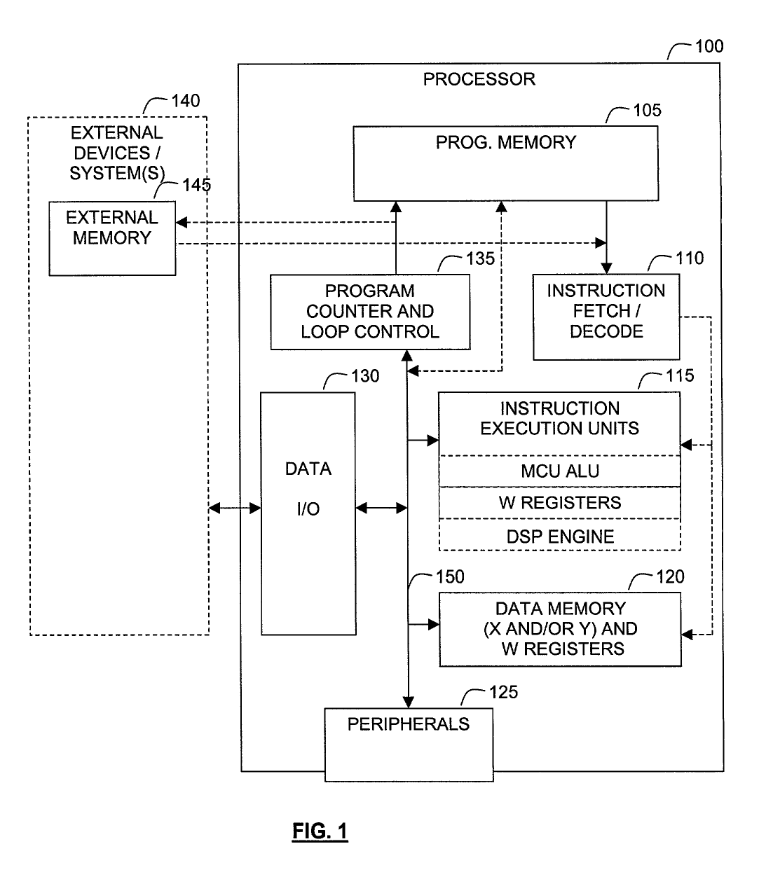

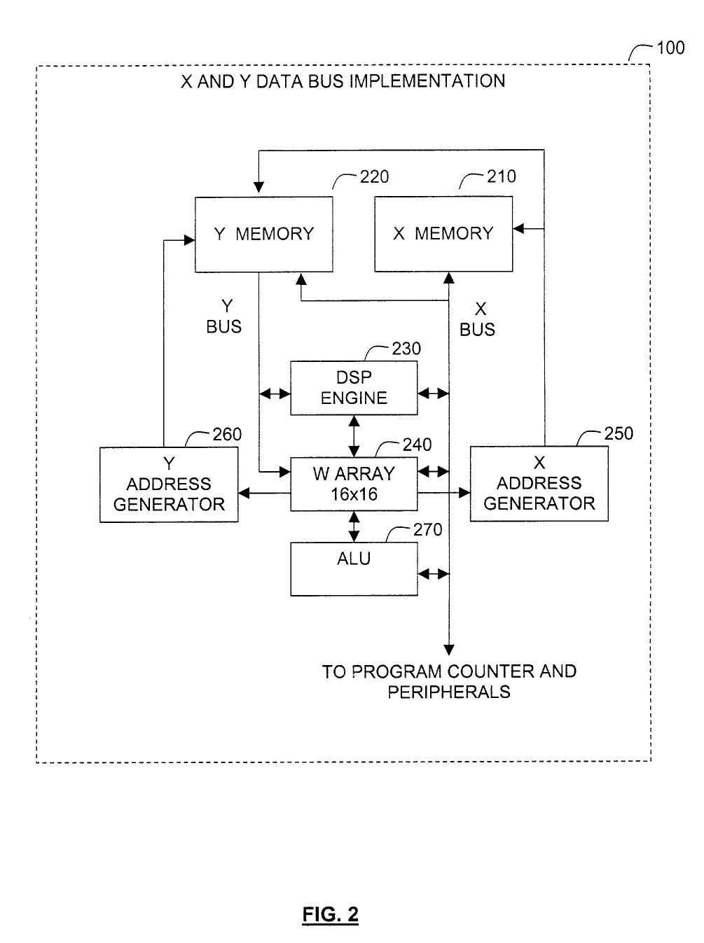

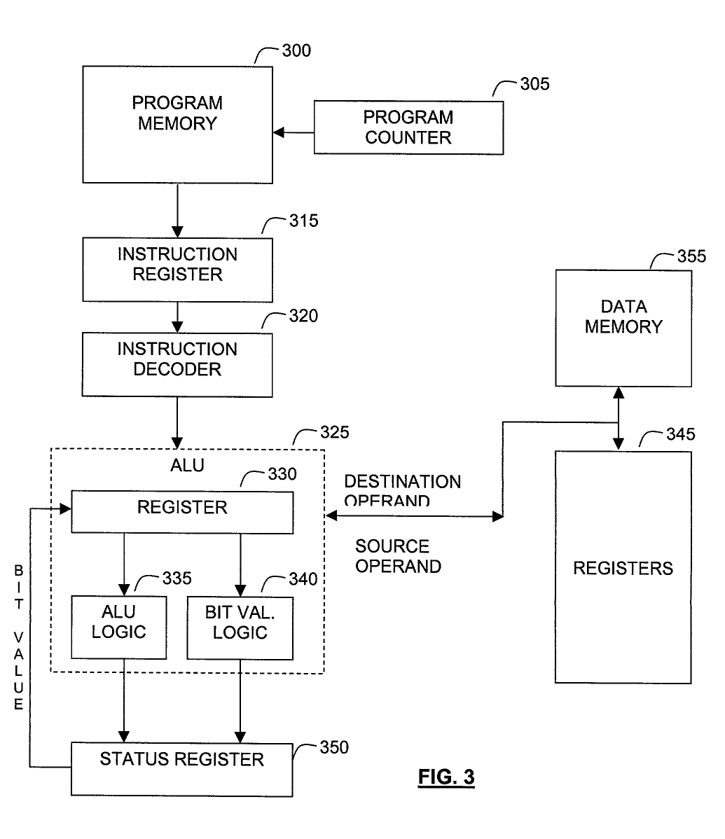

In order to describe embodiments of bit value transfer operation instruction processing, an overview of pertinent processor elements is first presented with reference to FIGS. 1 and 2. The bit transfer operation instructions and instruction processing is then described more particularly with reference to FIGS. 3-5.

Overview of Processor Elements

FIG. 1 depicts a functional block diagram of an embodiment of a processor chip within which the present invention may find application. Referring to FIG. 1, a processor 100 is coupled to external devices/systems 140. The processor 100 may be any type of processor including, for example, a digital signal processor (DSP), a microprocessor, a microcontroller or combinations thereof. The external devices 140 may be any type of systems or devices including input/output devices such as keyboards, displays, speakers, microphones, memory, or other systems which may or may not include processors. Moreover, the processor 100 and the external devices 140 may together comprise a stand alone system.

The processor 100 includes a program memory 105, an instruction fetch/decode unit 110, instruction execution units 115, data memory and registers 120, peripherals 125, data I/O 130, and a program counter and loop control unit 135. The bus 150, which may include one or more common buses, communicates data between the units as shown.

The program memory 105 stores software embodied in program instructions for execution by the processor 100. The program memory 105 may comprise any type of nonvolatile memory such as a read only memory (ROM), a programmable read only memory (PROM), an electrically programmable or an electrically programmable and erasable read only memory (EPROM or EEPROM) or flash memory. In addition, the program memory 105 may be supplemented with external nonvolatile memory 145 as shown to increase the complexity of software available to the processor 100. Alternatively, the program memory may be volatile memory which receives program instructions from, for example, an external non-volatile memory 145. When the program memory 105 is nonvolatile memory, the program memory may be programmed at the time of manufacturing the processor 100 or prior to or during implementation of the processor 100 within a system. In the latter scenario, the processor 100 may be programmed through a process called in-line serial programming.

The instruction fetch/decode unit 110 is coupled to the program memory 105, the instruction execution units 115 and the data memory 120. Coupled to the program memory 105 and the bus 150 is the program counter and loop control unit 135. The instruction fetch/decode unit 110 fetches the instructions from the program memory 105 specified by the address value contained in the program counter 135. The instruction fetch/decode unit 110 then decodes the fetched instructions and sends the decoded instructions to the appropriate execution unit 115. The instruction fetch/decode unit 110 may also send operand information including addresses of data to the data memory 120 and to functional elements that access the registers.

The program counter and loop control unit 135 includes a program counter register (not shown) which stores an address of the next instruction to be fetched. During normal instruction processing, the program counter register may be incremented to cause sequential instructions to be fetched. Alternatively, the program counter value may be altered by loading a new value into it via the bus 150. The new value may be derived based on decoding and executing a flow control instruction such as, for example, a branch instruction. In addition, the loop control portion of the program counter and loop control unit 135 may be used to provide repeat instruction processing and repeat loop control as further described below.

The instruction execution units 115 receive the decoded instructions from the instruction fetch/decode unit 110 and thereafter execute the decoded instructions. As part of this process, the execution units may retrieve one or two operands via the bus 150 and store the result into a register or memory location within the data memory 120. The execution units may include an arithmetic logic unit (ALU) such as those typically found in a microcontroller. The execution units may also include a digital signal processing engine, a floating point processor, an integer processor or any other convenient execution unit. A preferred embodiment of the execution units and their interaction with the bus 150, which may include one or more buses, is presented in more detail below with reference to FIG. 2.

The data memory and registers 120 are volatile memory and are used to store data used and generated by the execution units. The data memory 120 and program memory 105 are preferably separate memories for storing data and program instructions respectively. This format is a known generally as a Harvard architecture. It is noted, however, that according to the present invention, the architecture may be a Von-Neuman architecture or a modified Harvard architecture which permits the use of some program space for data space. A dotted line is shown, for example, connecting the program memory 105 to the bus 150. This path may include logic for aligning data reads from program space such as, for example, during table reads from program space to data memory 120.

Referring again to FIG. 1, a plurality of peripherals 125 on the processor may be coupled to the bus 125. The peripherals may include, for example, analog to digital converters, timers, bus interfaces and protocols such as, for example, the controller area network (CAN) protocol or the Universal Serial Bus (USB) protocol and other peripherals. The peripherals exchange data over the bus 150 with the other units.

The data I/O unit 130 may include transceivers and other logic for interfacing with the external devices/systems 140. The data I/O unit 130 may further include functionality to permit in circuit serial programming of the Program memory through the data I/O unit 130.

FIG. 2 depicts a functional block diagram of a data busing scheme for use in a processor 100, such as that shown in FIG. 1, which has an integrated microcontroller arithmetic logic unit (ALU) 270 and a digital signal processing (DSP) engine 230. This configuration may be used to integrate DSP functionality to an existing microcontroller core. Referring to FIG. 2, the data memory 120 of FIG. 1 is implemented as two separate memories: an X-memory 210 and a Y-memory 220, each being respectively addressable by an X-address generator 250 and a Y-address generator 260. The X-address generator may also permit addressing the Y-memory space thus making the data space appear like a single contiguous memory space when addressed from the X address generator. The bus 150 may be implemented as two buses, one for each of the X and Y memory, to permit simultaneous fetching of data from the X and Y memories.

The W registers 240 are general purpose address and/or data registers. The DSP engine 230 is coupled to both the X and Y memory buses and to the W registers 240. The DSP engine 230 may simultaneously fetch data from each the X and Y memory, execute instructions which operate on the simultaneously fetched data and write the result to an accumulator (not shown) and write a prior result to X or Y memory or to the W registers 240 within a single processor cycle.

In one embodiment, the ALU 270 may be coupled only to the X memory bus and may only fetch data from the X bus. However, the X and Y memories 210 and 220 may be addressed as a single memory space by the X address generator in order to make the data memory segregation transparent to the ALU 270. The memory locations within the X and Y memories may be addressed by values stored in the W registers 240.

Any processor clocking scheme may be implemented for fetching and executing instructions. A specific example follows, however, to illustrate an embodiment of the present invention. Each instruction cycle is comprised of four Q clock cycles Q1-Q4. The four phase Q cycles provide timing signals to coordinate the decode, read, process data and write data portions of each instruction cycle.

According to one embodiment of the processor 100, the processor 100 concurrently performs two operations—it fetches the next instruction and executes the present instruction. Accordingly, the two processes occur simultaneously. The following sequence of events may comprise, for example, the fetch instruction cycle:

| | |
|---|---|
| Q1: | Fetch Instruction |
| Q2: | Fetch Instruction |
| Q3: | Fetch Instruction |
| Q4: | Latch Instruction into prefetch register, Increment PC |

The following sequence of events may comprise, for example, the execute instruction cycle for a single operand instruction:

| | |
|---|---|
| Q1: | latch instruction into IR, decode and determine addresses of |
| | operand data |
| Q2: | fetch operand |
| Q3: | execute function specified by instruction and calculate |
| | destination address for data |
| Q4: | write result to destination |

The following sequence of events may comprise, for example, the execute instruction cycle for a dual operand instruction using a data pre-fetch mechanism. These instructions pre-fetch the dual operands simultaneously from the X and Y data memories and store them into registers specified in the instruction. They simultaneously allow instruction execution on the operands fetched during the previous cycle.

| | |
|---|---|
| Q1: | latch instruction into IR, decode and determine addresses of |
| | operand data |
| Q2: | pre-fetch operands into specified registers, execute operation |
| | in instruction |
| Q3: | execute operation in instruction, calculate destination address |
| | for data |
| Q4: | complete execution, write result to destination |

Bit Value Transfer Operation Instruction Processing

FIG. 3 depicts a functional block diagram of a processor for processing bit value transfer operation instructions according to the present invention. Referring to FIG. 3, the processor includes a program memory 300 for storing instructions such as the bit value transfer operation instructions depicted in FIG. 5. The processor also includes a program counter 305 which stores a pointer to the next program instruction that is to be fetched. The processor further includes an instruction register 315 for storing an instruction for execution that has been fetched from the program memory 300. The processor may further include pre-fetch registers (not shown) that may be used for fetching and storing a series of upcoming instructions for decoding and execution. The processor also includes an instruction decoder 320, an arithmetic logic unit (ALU) 325, registers 345 and a status register 350.

The instruction decoder 320 decodes instructions, such as bit value transfer operation instructions, that are stored in the instruction register 315. Based on the combination of bits in the instruction, the instruction decoder 320 selectively activates logic within the ALU 325 for fetching operands, performing the operation specified by the instruction and producing an output in accordance with the instruction to the appropriate data memory location. The instruction decoder decodes particular bits in bit value transfer operation instructions and sends control signals to the ALU. The control signals direct the ALU to select a bit value in a source bit position specified by a flag bit or position bits in the instructions, receive an operand from a data memory location specified by data memory bits in the instruction, select an addressing mode specified by address mode bits, and write the bit value to a destination bit position specified by a flag bit or position bits in the instructions.

The ALU 325 includes registers 330 that may receive one or more operands from the registers 345 and/or a data memory location 355. The origin of the one or more operands depends on the addressing mode defined by the combination of address mode bit used in the instruction. For example, one combination of address mode bits obtains an operand from the registers 345. Another combination of address mode bits obtains the operand from an address location in the data memory 355.

The ALU 325 includes ALU logic 335 and bit value transfer operation logic 340, each of which may receive the one or more operands from the registers 330. The operands may include a data word, a data byte and a data bit. The ALU logic 335 executes arithmetic and logic operations according to instructions decoded by the instruction decoder on the one or more operands fetched from the registers 345 and/or from address location in the data memory 345. The ALU logic 335 produces outputs in accordance with the arithmetic and logic operations to one of registers 345 and/or the status register 350.

The bit value transfer operation logic 340 may be part of or separate from the ALU logic 335. The bit transfer operation logic, however, is logically separate from the ALU logic 335 and is activated upon the execution of one of a bit value transfer operation instruction shown in FIG. 5. The bit value transfer operation logic 340 may receive one or more operands from the registers 330. The operands may include a data word, a data byte and a data bit. The bit transfer operation logic may execute bit value transfer operation according to the instructions decoded by the instruction decoder on an operand contained in registers 345, status register 350 and/or an address location in data memory 355.

In this regard, when a bit value transfer operation instruction, such as one of those depicted in FIG. 5, is presented to the instruction decoder 320, the instruction decoder generates control signals which cause the ALU to fetch a source operand from the registers 345 or from the data memory 355 and which cause the bit operation logic 340 to operate on the fetched source operand to produce a result in accordance with the instruction. For example, the control signals can cause the ALU to fetch a source operand from a data memory location, select a bit value in a bit position of the source operand at the data memory location, copy the bit value at the bit position and write the bit value to a destination bit position at another data memory location. Alternatively, the control signals can cause the ALU to fetch a source operand from a data memory location, select a bit value in a bit position of the source operand at another data memory location, copy the bit value at the bit position and write the bit value to a destination bit position at the initial data memory location. The result depends upon the instruction executed and the source operand as is explained below in more detail. After generating the result, the instruction decoder causes the result to be written back into the correct register 345 or memory location within the data memory 355.

The bit transfer operation logic may include logic for implementing four different bit value transfer operation instructions. Each of these instructions selects a bit value contained in a source bit position of a data memory location and writes the bit value to a destination bit position of another data memory location. Moreover, the instructions specify a source bit position of a data memory location containing a bit value to select, a destination bit position of another data memory location to write the bit value, and the data memory location of an operand from which to read or write the bit value. The logic for implementing each instruction is selectively activated by the instruction decoder 320 when that particular instruction is decoded.

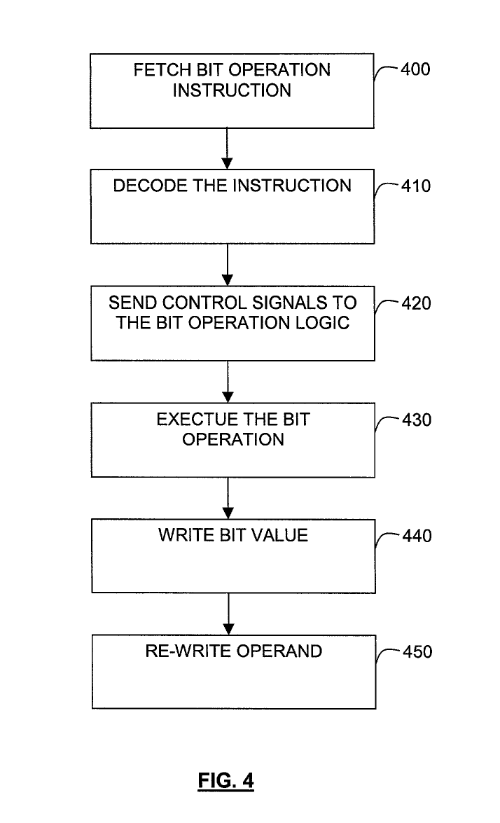

FIG. 4 depicts a method of processing bit value transfer operation instructions according to embodiments of the present invention. Referring to FIG. 4, in step 400, the processor fetches a bit value transfer operation instruction from the program memory 300. Then in step 410, the instruction decoder 320 decodes the bit value transfer operation instruction. The bit value transfer operation instruction may specify a source bit position of a data memory location containing a bit value to select, a destination bit position of another data memory location to write the bit value, and the data memory location of an operand from which to read or write the bit value.

In step 420, the processor causes control signals to be sent to the ALU 325 and the bit operation logic 340 within the ALU. The control signals sent are based on bits in the bit value transfer operation instruction. The control signals indicate the position of a bit value to select, a data memory location to write the bit value, and the data memory location of an operand from which to read or write the bit value. In step 430, the processor executes the decoded bit value transfer operation instruction. The execution of the bit value transfer operation may include reading an operand, selecting a bit value at a bit position of the operand or a data memory location and copying the bit value at the bit position. In an embodiment of the present invention, the bit value is selected from a bit position of an operand read from a data memory location. In an embodiment of the present invention, the bit value is selected directly from the bit position of a data memory location. Then in step 440, the processor writes the bit value to a bit position of a destination location. The bit value may be written to a bit position of data memory location or a bit position of an operand. In an embodiment of the present invention, the bit value is written to a bit position of an operand, if the bit value is selected directly from a bit position of a data memory location. In an of the present invention, the bit value is written to a bit position of a data memory location, if the bit value is selected from an operand read from a data memory location. In step 450, the processor may re-write fetched operands to the data memory location from which they were read.

While specific embodiments of the present invention have been illustrated and described, it will be understood by those having ordinary skill in the art that changes may be made to those embodiments without departing from the spirit and scope of the invention.

What is claimed is:

1. A method of processing a bit transfer operation instruction, comprising:
fetching and decoding a bit value transfer instruction;
executing the bit value transfer instruction on a source bit position of a first data memory location to select a bit value in the source bit position of the first data memory location, the bit position of the first data memory location specified in the bit value transfer instruction;
writing the value to a destination bit position of a second data memory location, the destination bit position specified in the bit value transfer instruction.

2. The method according to claim 1, wherein the step of executing the bit value transfer instruction includes reading an operand at the first memory location.

3. The method according to claim 2, wherein the step of executing the bit value transfer instruction includes copying the bit value at the source bit position of the operand.

4. The method according to claim 3, wherein the step of executing the bit value transfer instruction includes writing the operand to the first memory location.

5. The method according to claim 4, wherein the bit value transfer instruction is a first test bit value transfer instruction.

6. The method according to claim 5, wherein the first test bit value transfer instruction specifies a carry status bit position as the destination bit position of the second memory location.

7. The method according to claim 6, wherein the first test bit value transfer instruction specifies a register as the first data memory location.

8. The method according to claim 6, wherein the first test bit value transfer instruction specifies an address in data memory as the first data memory location.

9. The method according to claim 4, wherein the bit value transfer instruction is a second test bit value transfer instruction.

10. The method according to claim 9, wherein the second test bit value transfer instruction specifies a zero status bit position as the destination bit position of the second memory location.

11. The method according to claim 10, wherein the second test bit value transfer instruction specifies a register as the first data memory location.

12. The method according to claim 10, wherein the second test bit value transfer instruction specifies an address in data memory as the first data memory location.

13. The method according to claim 1, wherein the step of executing the bit value transfer instruction includes reading an operand at the second memory location.

14. The method according to claim 13, wherein the step of executing the bit value transfer instruction includes copying the bit value at the source bit position of the first memory location.

15. The method according to claim 14, wherein the step of executing the bit value transfer instruction includes writing the operand to the second memory location.

16. The method according to claim 15, wherein the bit value transfer instruction is a first write bit value transfer instruction.

17. The method according to claim 16, wherein the first write bit value transfer instruction specifies a zero status bit position as the source bit position of the first memory location.

18. The method according to claim 17, wherein the first write bit value transfer instruction specifies a register as the second data memory location.

19. The method according to claim 17, wherein the first write bit value transfer instruction specifies an address in data memory as the second data memory location.

20. The method according to claim 15, wherein the bit value transfer instruction is a second write bit value transfer instruction.

21. The method according to claim 20, wherein the second write bit value transfer instruction specifies a carry status bit position as the source bit position of the first memory location.

22. The method according to claim 21, wherein the second write bit value transfer instruction specifies a register as the second data memory location.

23. The method according to claim 21, wherein the second write bit value transfer instruction specifies an address in data memory as the second data memory location.

24. A processor for bit transfer operation instruction processing, comprising:
a program memory for storing instructions including a bit value transfer operation instruction;
a program counter for identifying current instructions for processing; and
an arithmetic logic unit (ALU) for executing instructions within the program memory, the ALU including bit value transfer operation logic for executing the bit value transfer operation instruction on a source bit position of a first data memory location to select a bit value in the source bit position of the first data memory location, the bit position of the first data memory location specified in the bit value transfer instruction and writing the value to a destination bit position of a second data memory location, the destination bit position specified in the bit value transfer instruction.

25. The processor according to claim 24, wherein the step of executing the bit value transfer instruction includes the ALU reading an operand at the address in the first memory location.

26. The processor according to claim 25, wherein the step of executing the bit value transfer instruction includes the ALU copying the bit value at the source bit position of the operand.

27. The processor according to claim 26, wherein the step of executing the bit value transfer instruction includes the ALU writing the operand to the address in the first memory location.

28. The processor according to claim 27, wherein the bit value transfer instruction is a first test bit value transfer instruction.

29. The processor according to claim 28, wherein the first test bit value transfer instruction specifies a carry status bit position as the destination bit position of the second memory location.

30. The processor according to claim 29, wherein the first test bit value transfer instruction specifies a register as the first data memory location.

31. The processor according to claim 29, wherein the first test bit value transfer instruction specifies an address in data memory as the first data memory location.

32. The processor according to claim 27, wherein the bit value transfer instruction is a second test bit value transfer instruction.

33. The processor according to claim 32, wherein the second test bit value transfer instruction specifies a zero status bit position as the destination bit position of the second memory location.

34. The processor according to claim 33, wherein the second test bit value transfer instruction specifies a register as the first data memory location.

35. The processor according to claim 33, wherein the second test bit value transfer instruction specifies an address in data memory as the first data memory location.

36. The processor according to claim 24, wherein the step of executing the bit value transfer instruction includes the ALU reading an operand at the address in the second memory location.

37. The processor according to claim 36, wherein the step of executing the bit value transfer instruction includes the ALU copying the bit value at the source bit position of the first memory location.

38. The method according to claim 37, wherein the step of executing the bit value transfer instruction includes the ALU writing the operand to the address in the second memory location.

39. The processor according to claim 38, wherein the bit value transfer instruction is a first write bit value transfer instruction.

40. The processor according to claim 39, wherein the first write bit value transfer instruction specifies a zero status bit position as the source bit position of the first memory location.

41. The processor according to claim 40, wherein the first write bit value transfer instruction specifies a register as the second data memory location.

42. The processor according to claim 40, wherein the first write bit value transfer instruction specifies an address in data memory as the second data memory location.

43. The processor according to claim 38, wherein the bit value transfer instruction is a second write bit value transfer instruction.

44. The processor according to claim 43, wherein the second write bit value transfer instruction specifies a carry status bit position as the source bit position of the first memory location.

45. The processor according to claim 44, wherein the second write bit value transfer instruction specifies a register as the second data memory location.

46. The processor according to claim 44, wherein the second write bit value transfer instruction specifies an address in data memory as the second data memory location.
